(19) United States
(12) Patent Application Publication
(10) Pub. No.: US 2023/0350270 A1
(43) Pub. Date: Nov. 2, 2023

(54) OPTICAL LOGIC CIRCUIT DEVICES AND METHODS THEREOF

(71) Applicants: Juan M. Merlo-Ramirez, Hyde Park, NY (US); Michael J. Naughton, Waltham, MA (US)

(72) Inventors: Juan M. Merlo-Ramirez, Hyde Park, NY (US); Michael J. Naughton, Waltham, MA (US)

(73) Assignee: The Trustees of Boston College, Chestnut Hill, MA (US)

(21) Appl. No.: 18/140,384

(22) Filed: Apr. 27, 2023

Related U.S. Application Data
(60) Provisional application No. 63/335,344, filed on Apr. 27, 2022.

(51) Int. Cl. G02F 3/00; G02F 1/313

(52) U.S. Cl. CPC G02F 3/00; G02F 1/3136

(57) ABSTRACT

The present technology relates to an optical logic circuit device. The optical logic circuit device includes a first input port and a second input port. A symmetric arrangement of waveguides is coupled to the first input port and the second input port. The symmetric arrangement of waveguides having a pair of topologically protected edge states that provide propagation paths through the symmetric arrangement of waveguides. An output port is coupled to the symmetric arrangement of waveguides. Methods of fabricating and using the optical logic circuit device are also disclosed.

This application claims the benefit of the filing date of U.S. Provisional Pat. Application Serial No. 63/335,344, filed Apr. 27, 2022, which is hereby incorporated by reference in its entirety.

### FIELD

This application relates to optical logic circuitry. More specifically, the present technology relates to an optical logic circuit device that utilizes topologically protected edge states. This application also relates to methods of operating the optical logic circuit device, as well as an optical computing device including the optical logic circuit device.

### BACKGROUND

Topological photonics is an incipient research area where the well-developed theory and applications of so-called topological insulators (TIs) is applied to photonic systems. The properties of TIs are evoked with the use of electromagnetic fields in specially-designed materials and structures. The notion of a photonic topological insulator (PTI) is due to Haldane, who proposed the use of non-reciprocal media breaking time-reversal symmetry in a photonic crystal. Many interesting demonstrations have been reported on this matter, including unidirectional waveguides. Although the vast majority of PTI reports have used photonic crystals, a different approach is the use of evanescently-coupled ring waveguides. In this configuration, a crystalline-like structure of alternating resonant and non-resonant rings was used and it was possible to emulate the characteristic edge states reported in PTIs.

In the realization of PTIs based on ring waveguides, two approaches have been reported: (1) a configuration that resembles the quantum Hall effect, where a synthetic magnetic field is generated by an additional phase in the circulation of light in a lattice of the PTI, depending on the direction of circulation, and (2) a symmetric configuration that does not depend on a synthetic magnetic field, but ensures the appearance of topologically-protected edge states, emulating the anomalous quantum Hall effect. Due to the absence of broken time-reversal symmetry in the second case, one can find topologically non-trivial phases with robust topologically-protected edge modes, but with Chern number equal to zero. This is enforced by the fact that the Chern number of a band must remain equal to the difference between the numbers of chiral edge modes entering the band from below and exiting above. However, in contrast to static two-band systems (e.g. Haldane model), where each band introduces only one chiral mode into the gap, in Floquet periodically-driven systems, the spectrum is not bound, and thus each band has an equal number of chiral modes below and above, necessarily zeroing the Chern numbers.

One of the building blocks of future all-optical computers will be all-optical logic gates. However, few advances have been done in this direction.

The present application is directed to overcoming these and other deficiencies in the art.

### SUMMARY

One aspect of the present technology relates to an optical logic circuit device. The optical logic circuit device includes a first input port and a second input port. A symmetric arrangement of waveguides is coupled to the first input port and the second input port. The symmetric arrangement of waveguides having a pair of topologically protected edge states that provide propagation paths through the symmetric arrangement of waveguides. An output port is coupled to the symmetric arrangement of waveguides.

Another aspect of the present technology relates to an optical computing device comprising a plurality of the optical logic circuit devices disclosed herein.

A further aspect of the present technology relates to a method of forming an optical logic gate. The method includes: (i) providing a first input port and a second input port; (ii) coupling a symmetric arrangement of waveguides to the first input port and the second input port, the symmetric arrangement of waveguides having a pair of topologically protected edge states that provide propagation paths through the symmetric arrangement of waveguides; and (iii) coupling an output port to the symmetric arrangement of waveguides.

Yet another aspect of the present technology relates to a method of operating the optical logic gate disclosed herein. The method includes selectively providing excitation energy to the first input port and the second input port, wherein the symmetric arrangement of waveguides transmit light through the propagation paths to the output port only when excitation energy is applied to either the first input port or the second input port.

The present technology provides an optical logic circuit device that employs topologically-protected logic circuitry for the control of light by light in the visible range. The use of visible range wavelengths enhances the transfer speed of information and, more importantly, allows for the reduction in size of devices. However, the optical logic circuit device can be modified to be used in various portions of the electromagnetic spectrum from radiofrequency (RF) to deep ultraviolet (including visible, infrared, and ultraviolet) with pertinent modifications to the structure of the optical logic circuit device. For example, the optical logic circuit device could be employed in the near infrared spectrum to be used in Si photonics technology. An all-optical computer can be built using the topologically-protected optical logic circuitry as building blocks. The optical logic circuit device can be employed, for example, to develop optical logic gates for computations, and optical guides for communications, interconnects, biosensors, etc.

The present technology utilizes the application of photonic topologically-protected edge states in the anomalous Floquet photonic topological insulator structures to develop an optical logic circuit device that is able to behave as OR, AND, and XOR logic gates, depending on the characteristics of the excitation field. Materials and dimensions of the device are amenable to conventional fabrication methods, opening the possibility for implementation in on-chip photonic communication technology.

### BRIEF DESCRIPTION OF THE DRAWINGS

FIG. 1 is a schematic of an exemplary of an optical logic circuit device including a detailed inset of a portion thereof of the present disclosure.

FIGS. 2A and 2B illustrate a simulation of the topologically protected edge states for the optical logic circuit device shown in FIG. 1.

FIGS. 3A-3C illustrate a simulation that demonstrates the robustness of an edge mode on a 2 × 2 optical logic circuit device having no defects (3A), one site defect (3B), and two site defects.

FIGS. 4A-4D illustrate a simulation that demonstrates the robustness of an edge mode on a 3 × 3 optical logic circuit device having no defects (4A), a link ring defect (4B), a site ring defects (4C), and a lattice site defect (4D).

FIG. 5 is a block diagram of an exemplary optical computing device including a plurality of optical logic circuit devices.

FIGS. 6A-6C show a simulated demonstration of OR logic action where A=B=1 (both inputs are ON) and the output is 1 (ON) (5A); A=0 (OFF), B=1 (ON), and the output is 1 (ON) (5B); and A=1 (ON), B=0 (OFF), and the output is 1 (ON) (5C).

FIGS. 7A-7C show a simulated demonstration of XOR logic action. For XOR (exclusive OR) logic, the excitation of the inputs and the phase differences are used. Three schemes are shown: the phase difference between A and B is π (both inputs are ON) and the output is 1 (OFF) (7A); A=0 (OFF), B=1 (ON, regardless of phase), and the output is 1 (ON) (7B); and A=1 (ON, no matter the phase), B=0 (OFF), and the output is 1 (ON) (7C).

FIGS. 8A-8C show a simulated demonstration of AND logic action. For the case of the AND gate, the logic is not based on the ON/OFF of the excitation energy, but rather on the phase difference between excitation inputs. Three schemes are shown, this time reported as phase difference: the phase difference between A and B is 0 (both inputs are ON) and the output is 1 (ON) (8A); A/B has a phase difference of π radians (OFF) with respect to B/A (ON), and the output is 0 (OFF) (8B and 8C).

FIGS. 9A-9C show a simulated demonstration of a two-bit computer. FIG. 9A shows a sum of 1+0 (A=ON and B=OFF) resulting in LSB=1 (ON) or decimal 1. FIG. 9B shows a sum of 0+1 (A=OFF and B=ON) resulting in LSB=1 (ON) or decimal 1. FIG. 9C shows a sum 1+1 (A=ON and B=ON) resulting in MSB=1 (ON) or decimal 2. The inset shows a table with the equivalent operations. LSB means least significant bit, and MSB means most significant bit.

FIGS. 10A-10E show a simulated demonstration of the robustness of the calculation of 1 + 1. FIG. 10A shows XOR and AND gates with no defects on their structure. FIG. 10B shows three site ring and link ring defects on AND gate, no defect on XOR. FIG. 10C shows four site ring and link ring defects on AND gate, no defect on XOR. FIG. 10D shows four site ring and link ring defects on AND gate and one lattice site defect on XOR. FIG. 10E shows four site ring and link ring defects on AND gate and four SR and three LR defects on XOR.

FIGS. 11A and 11B illustrate simulation results for the optical logic circuit device including: coupling strength factor (θ) as function of separation gap and operation frequency (11A); and coupling strength factor at 451 THz, for separation gaps running from 30 nm to 150 nm (11B). The shaded region highlights the gap sizes for strong coupling.

FIGS. 12A-12E illustrate band diagrams for various separation gap values.

FIGS. 13A-13C illustrate normalized intensity distribution in the optical logic circuit device. FIG. 13A shows a bulk mode for 448 THz. FIG. 13B shows an edge mode for 451 THz. Both (a) and (b) are selected from frequencies highlighted as triangle and star, respectively, in FIG. 12E for SG of 40 nm. FIG. 13C shows robustness of the edge mode when a lattice site is removed. In all the images, the shapes represent the waveguides in the device.

### DETAILED DESCRIPTION

This application relates to optical logic circuitry. More specifically, the present technology relates to an optical logic circuit device that utilizes topologically protected edge states. This application also relates to methods of fabricating and operating the optical logic circuit device, as well as an optical computing device including the optical logic circuit device.

One aspect of the present technology relates to an optical logic circuit device. The optical logic circuit device includes a first input port and a second input port. A symmetric arrangement of waveguides is coupled to the first input port and the second input port. The symmetric arrangement of waveguides having a pair of topologically protected edge states that provide propagation paths through the symmetric arrangement of waveguides. An output port is coupled to the symmetric arrangement of waveguides.

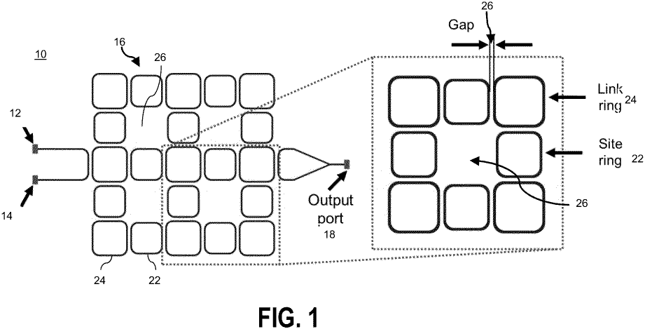

FIG. 1 illustrates an optical logic circuit device 10 of the present disclosure. The optical logic circuit device 10 includes a first input port 12 and a second input port 14, a symmetrical arrangement of waveguides 16, and an output port 18, although the optical logic circuit device 10 could include other types and/or numbers of elements in other combinations. The first and second input ports 12 and 14 are configured to selectively receive a light input therein. The optical logic circuit device 10 can be modified to be used with a light input in various portions of the electromagnetic spectrum from radiofrequency (RF) to deep ultraviolet (including visible, infrared, and ultraviolet) based on modifications to the structure of the optical logic circuit device. For example, the optical logic circuit device 10 could be employed in the near infrared spectrum to be used in Si photonics technology. The design can be applied to a wide range of frequencies and a larger number of logic gates to perform complex calculations.

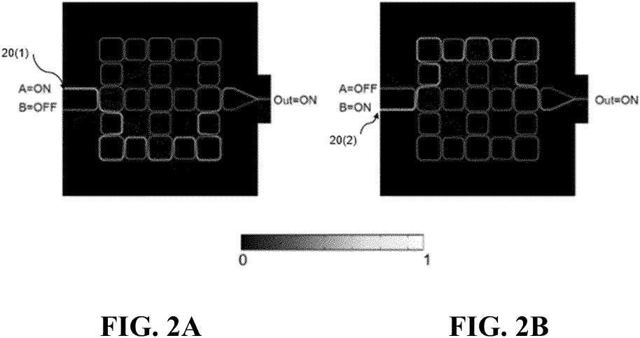

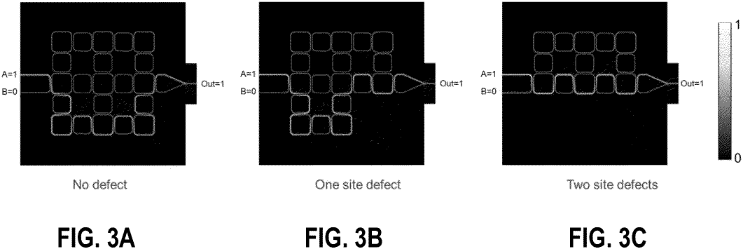

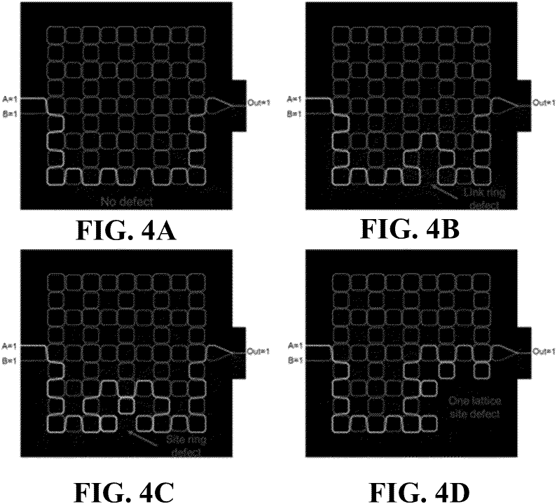

The optical logic circuit device 10 further includes a symmetric arrangement of waveguides 16 coupled to the first input port 12 and the second input port 14. Referring to FIGS. 2A and 2B, the symmetric arrangement of waveguides 16 is configured to provide a pair of topologically protected edge states that provide propagation paths 20(1) and 20(2) through the symmetric arrangement of waveguides 16. In the example shown in FIGS. 1, 2A, and 2B, the symmetric arrangement of waveguides 16 includes topologically protected edge states at both an lower edge of the device, as well as in the upper edge to provide the propagation paths 20(1) and 20(2), respectively. The propagation of light through the propagation paths 20(1) and 20(2) is robust and not impacted by defects in the lattice as demonstrated in FIGS. 3A-3B, which illustrate the propagation path 20(2) where there are no defects (FIG. 3A), one site defect (FIG. 3B), and two site defects (FIG. 3C), respectively. The inclusion of defects in the lattice (FIGS. 3B and 3C) does not affect the transmission of the electromagnetic field at the output port 18. Indeed, the electromagnetic field finds new edges to propagate along, a property of topologically-protected edge states. Extension of the size of the optical logic circuit device 10 is allowed by the configuration shown in FIGS. 4A-4D, which illustrates a 3 × 3 device. Similarly, the inclusion of defects under different considerations: a) no defects; b) a link ring defect; c) a site ring defect; and d) one lattice site defect, does not impact the transmission. Instead, the transmission of the electromagnetic energy is still ensured due to the topologically-protected edge states. The symmetry of the optical logic circuit device 10 allows for the operation of the optical logic circuit device 10 to serve as an optical gate as described in further detail below.

Referring again to FIG. 1, the symmetric arrangement of waveguides 16 includes a plurality of site rings 22 and a plurality of link rings 24, each separated by a separation gap 28. In this example, the plurality of site rings 22 and the plurality of link rings 24 are rectangular shaped with rounded corners. It is well known that the interaction between circular rings is confined to a small region that tends to a single point. In such a case, the requirements to reach the strong coupling regime - where evanescent coupling is sufficient to excite modes between neighboring rings - are very tight, meaning the separation gaps must be very small which increases the difficulty of production. Thus, the geometric configuration provided herein allows for easier fabrication. The geometry of the symmetric arrangement of waveguides 16 increases the interaction region, relaxing the requirements for the separation gap 28. As the interaction region located between the site rings 22 and the link rings 24 increases in length, as shown in FIG. 1, the topological transition runs to greater separation gaps 28, a convenient effect for a fabrication procedure.

The plurality of site rings 22 and the plurality of link rings 24 are formed of a material suitable for forming an optical waveguide, such as TiO₂ or silicon by way of example, although other suitable materials may be employed depending on the application. In particular, the dielectric contrast between the site rings 22 and link rings 24 as compared to the dielectric medium 26 must be high enough to guide the light in the rings and allow evanescent coupling in the spectral range at which the optical logic circuit device 10 is being operated. The plurality of site rings 22 and the plurality of link rings 24 are arranged in a lattice structure. Although the optical logic circuit device 10 shown in FIG. 1 has a 2 × 2 site lattice structure, it is to be understood that other sizes of lattice structures could be employed and the optical logic device 10 can be expanded to any number of sites. The plurality of site rings 22 and the plurality of link rings 24 are surrounded by a dielectric medium 26, such as air although other dielectric mediums may be employed.

Each of the plurality of site rings 22 are separated from a corresponding link ring 24 by the separation gap 28, such that the corresponding site ring 22 and link ring 24 are evanescently coupled. The plurality of site rings 22 have a resonant condition and the link rings 24 are antiresonant. The size of the separation gap 28 is determined based on the size of the plurality of site rings 22 and link rings 24, as well as the propagation wavelength of the light input to the input ports 12 and/or 14.

The plurality of site rings 22 the resonant condition given by the following equation:

$$β {L}_{S R} \text{=} 2 m π \qquad \text{(1)}$$

wherein β is the effective wavenumber of the propagated mode, L_{SR} is the length (circumference) of the site ring 22, and integer m is the mode order. The plurality of link rings 24 are antiresonant by design with the following condition:

$$β {L}_{L R} \text{=} β {L}_{S R} + π \qquad \text{(2)}$$

wherein L_{LR} the length of the link ring 24, meaning light was not allowed to generate a standing wave and consequently coupling to the next site ring 22. The design of the optical logic circuit device 10 emulates a crystalline structure where light takes the place of electrons in a condensed matter system.

A coupling strength factor (CSF) for the symmetric arrangement of waveguides 16 is defined by θ = sin⁻¹ (Iₒᵤₜ / Iᵢₙ), where Iᵢₙ and Iₒᵤₜ are the input and output optical intensities, respectively, as disclosed in Liang, et al., “Optical resonator analog of a two-dimensional topological insulator,” Phys. Rev. Lett., 110, 203904 (2013) and Pasek, et al., “Network models of photonic Floquet topological insulators,” Phys. Rev. Lett. B, 89, 075113 (2014), the disclosures of which are incorporated by reference herein in their entireties. In fact, three characteristics of anomalous Floquet photonic topological insulator devices based on ring waveguides are well-accepted: 1) weak-interactions are characterized by θ < π /4 ; 2) the topological transition occurs when θ ~ π /4; and 3) robust edge modes appear when θ ~ π /2.5, as disclosed in as disclosed in Liang, et al., “Optical resonator analog of a two-dimensional topological insulator,” Phys. Rev. Lett., 110, 203904 (2013), the disclosure of which is incorporated herein by reference in its entirety.

The optical logic circuit device 10 further includes an output port 18 coupled to the symmetric arrangement of waveguides 16. The output port 18 is configured to receive light delivered through the propagation paths 20(1) and 20(2).

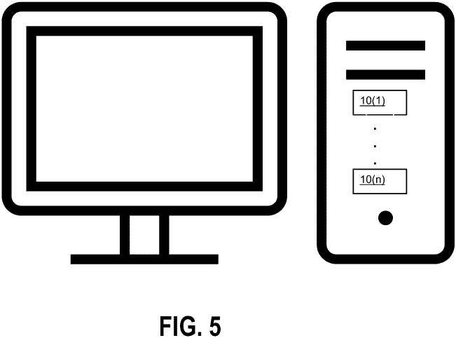

Another aspect of the present technology relates to an optical computing device comprising a plurality of the optical logic circuit devices disclosed herein. For example, an optical computing device 100 is illustrated in FIG. 5. The optical computing device 100 includes a plurality of optical logic circuit devices 10(1)-10(n). The plurality of optical logic circuit devices 10(1)-10(n) can be coupled together to perform any of the operations disclosed herein in various combinations. The optical computing device 100 can also include other computing device elements in various combinations known in the art such as memory, communication interfaces, processors, etc.

A further aspect of the present technology relates to a method of forming an optical logic gate. The method includes: (i) providing a first input port and a second input port; (ii) coupling a symmetric arrangement of waveguides to the first input port and the second input port, the symmetric arrangement of waveguides having a pair of topologically protected edge states that provide propagation paths through the symmetric arrangement of waveguides; and (iii) coupling an output port to the symmetric arrangement of waveguides.

The optical logic circuit device 10 as illustrated in FIG. 1 can be formed using electron beam lithography, by way of example only, although other methods of forming the optical logic circuit device 10 may be employed. For example, the plurality of site rings 22 and the plurality of link rings 24 may be formed using electron beam lithography. The plurality of site rings 22 and the plurality of link rings 24 can be formed in a lattice, with corresponding site rings 22 and link rings 24 separated by the separation gap 28. The plurality of site rings 22 and the plurality of link rings 24 are formed of a material suitable for forming an optical waveguide, such as TiO₂ or silicon by way of example, although other suitable materials may be employed depending on the application.

Yet another aspect of the present technology relates to a method of operating the optical logic gate disclosed herein. The method includes selectively providing excitation energy to the first input port and the second input port, wherein the symmetric arrangement of waveguides transmit light through the propagation paths to the output port only when excitation energy is applied to either the first input port or the second input port.

The optical logic circuit device 10 disclosed herein can be employed, for example, to perform one or more logic functions. The optical logic circuit device 10 can be employed in two different modes as described in further detail below. Using the methods disclosed herein, the optical logic circuit device 10 can be employed the as one of an OR gate, an XOR gate, or an AND gate, although other functions may be provided using the optical logical circuit device 10, or the plurality of optical circuit devices 10(1)-10(n), as shown in FIG. 5 in various combinations.

In order to simplify the discussion, ON/OFF states are described accordingly to the binary code, i.e., ON = 1 and OFF = 0. For the case of the output, a state is considered to be ON (OFF) when there is energy crossing (not crossing) the output port 18, as shown in FIG. 1. In addition, a topologically protected edge state in the optical logic circuit device 10 has two possible propagation paths 20(1) and 20(2), as shown in FIGS. 2A and 2B, meaning there is a protected state at the upper edge of the optical logic circuit device 10 (A = ON, B = OFF) as well as in the lower edge (A = OFF, B = ON). Thus, the symmetry of the device has as an important consequence, i.e., the ability to control the output at the output port 18 by using the methods described as follows:

In one example, the optical logic circuit device 10 is operated by selectively providing excitation energy to the first input port 12 and the second input port 14. In this example, the symmetric arrangement of waveguides 16 transmit light through the propagation paths 20(1) ad 20(2) to the output port 18 only when excitation energy is applied to either the first input port 12 or the second input port 14. The optical logic circuit device 10 will propagate light only when excitation energy is applied to one or both of the input ports 12 or 14, meaning an output of ON for input port 12 or 14 in an ON state (i.e., excitation energy applied), and output OFF for input ports 12 and 14 in an OFF state (i.e., no excitation energy applied).

In another example, the optical logic circuit device 10 is operated by providing the excitation energy simultaneously to the first input port 12 and the second input port 14 at a phase difference to alter light transmitted to the output port 18. For example, the excitation energy can be applied to the input port 12 and the output port 14 at a phase difference of π, such that no light is transmitted to the output port 18. In another example, the phase difference is zero such that light is transmitted to the output port 18.

Using the symmetric behavior of the device, as shown in FIGS. 2A and 2B, the output at the output port 18 can be controlled by interference of the incoming light in the triangular ring at the output port 18. As such, when the phase difference between the input ports 12 and 14 is 0, the output is ON, and OFF for a phase difference of π between the input ports 12 and 14.

Using these controls, it is possible to develop a set of all-optical logic gates, particularly OR, AND, and XOR logic, among the most important components of modern electronic technology. Although these logic gates are described due to the ability to perform basic calculations using them, it is to be understood that the present technology could be used to perform other logic functions.

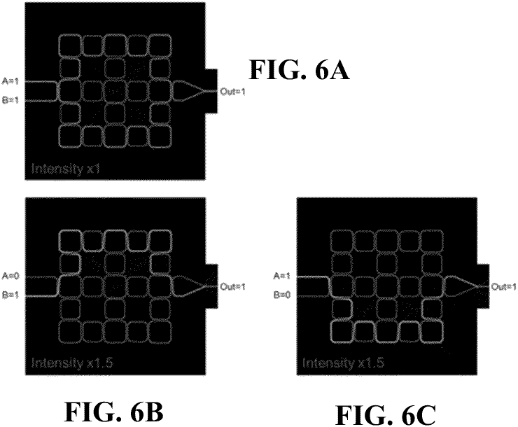

A simulation of the optical logic circuit device in use as an OR gate is shown in FIGS. 6A-6C. To provide an OR gate, the excitation energy can turned ON/OFF by selectively applying excitation energy to the input ports 12 and 14. In this way, when input ports 12 and 14 are ON (FIG. 6A), or when one of the input ports 12 or 14 is ON, the output was ON (FIGS. 6B and 6C); when both input ports 12 and 14 are OFF, the output was OFF (not shown). The functionality of the optical logic circuit device 10 as an OR gate is summarized in Table 1 below.

| A | B | OR Logic Output |
|---|---|---|
| 1 | 1 | 1 |
| 1 | 0 | 1 |
| 0 | 1 | 1 |
| 0 | 0 | 0 |

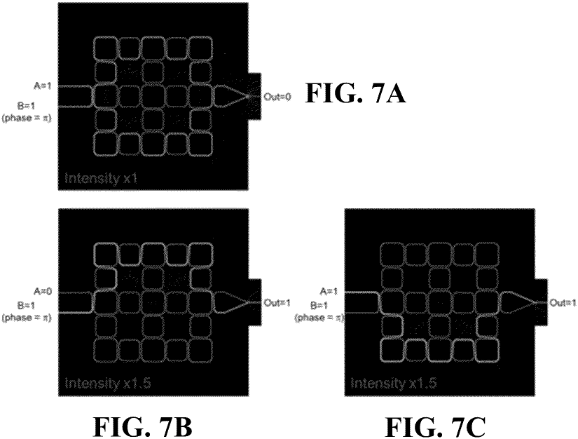

The optical logic circuit device 10 can also be used to provide an XOR gate as shown in FIGS. 7A-7C. The functionality of the optical logic circuit device 10 as an XOR gate is summarized in Table 2 below:

| A | B | XOR Logic Output |
|---|---|---|
| 1 | 1 | 0 |
| 0 | 1 | 1 |
| 1 | 0 | 1 |
| 0 | 0 | 0 |

The difference between OR and XOR logic is that, in the case of an XOR gate, the output is OFF when both inputs 12 and 14 are ON. By using phase control as described above, with a phase difference of π between inputs 12 and 14, the result was an output OFF even when input ports 12 and 14 were ON, as shown in FIG. 7A. For the next cases, the logic was not different from the OR logic, that is, when input ports 12 and 14 were ON, the output was ON, as shown in FIGS. 7B and 7C, respectively, and when the inputs 12 and 14 were both OFF, the output was OFF. This last case, where both inputs are off is not shown as it is also the trivial case.

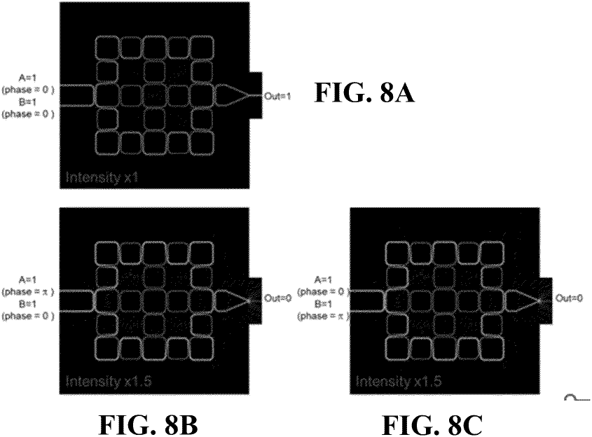

The optical logic circuit device 10 can also be used to provide an AND gate as shown in FIGS. 8A-8C. In the case of an AND gate, the optical logic circuit device 10 is controlled by shifting the phase between the inputs 12 and 14, as described above. The functionality of the optical logic circuit device 10 as a AND gate is summarized in Table 3 below:

| A | B | AND Logic Output |
|---|---|---|
| 1 | 1 | 1 |
| 1 | 0 | 0 |
| 0 | 1 | 0 |
| 0 | 0 | 0 |

The ON signal is defined when the excitation input has a phase of π, and OFF when it has a phase of 0. In this way, when input ports 12 and 14 were ON, the output was ON, and when input 12 was ON/OFF and input 14 was OFF/ON, the output was OFF. Although the ON/OFF states were defined in terms of the phase difference between the inputs 12 and 14 to obtain AND logic, the OFF state could also be obtained at the output 18 by turning off the excitation energy in both inputs 12 and 14 to complete the logic.

Although the logic OR, XOR, and AND are described above, it is to be understood that the optical logic circuit device 10 could be used to provide other functions in other combinations.

### Example 1 - Overview

All-optical logic gates using topologically-protected edge states were demonstrated by numerical models. By a systematic numerical analysis, optimal geometric configurations were determined when TiO₂ rectangular ring waveguides were used at 451 THz. These geometrical characteristics allow fabrication of devices using modern technologies having high-resolution lithography. Using two simple methods for output signal control, it was demonstrated how a single device can operate as an OR, XOR, or AND gate. Due to the topological nature of the device, inclusion of strong defects in the device structure do not affect the overall output. The result obtained by the implemented two bit calculator is not affected by the inclusion of defects in the structure of the composing logic gates. The photonic nature of the proposed device allows it to work in the high-speed information transmission range (GHz), limited only by the control phase commutation, and more importantly, reduced power consumption to levels that electronic devices are not capable of achieving.

### Example 2 - Methods

For numerical simulations, the finite element method using the COMSOL RF module (COMSOL AB, Stockholm, Sweden) in two dimensions. The use of TiO₂ ring waveguides immersed in vacuum was simulated. The refractive index of the TiO₂ waveguides was assumed constant and equal to 2.85, while the surrounding medium was considered to be 1.00. The difference between refractive indices ensures strong dielectric contrast, allowing for sufficient confinement of photonic modes.

The model was 2D (essentially exact for ring thickness << wavelength). The minimum mesh size was 1 nm while the maximum was 20 nm. The frequency used for the demonstrations of logic gates was fixed at 451 THz (665 nm free space wavelength). The excitation field was polarized in the direction pointing out of the page (relative to the optical logic circuit device shown in FIG. 1). The input E-field was delivered at the excitation port (input A/B) while the transmission was measured at the output port, (see FIG. 1A). Finally, the geometrical characteristics of the waveguides are the same for all results discussed, i.e. mode m = 20 and waveguide width 100 nm.

### Example 3 - Results

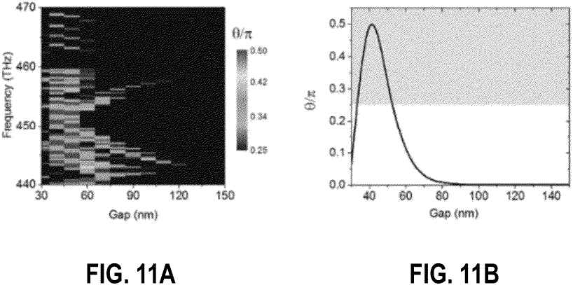

The coupling strength factor (CSF) was analyzed for a set of separation gaps (SGs) and frequencies as shown in FIG. 11, where the color scale ranges only to values that showed topological effects (θ > π /4). For the particular case when the frequency is 451 THz, as expected, the topological transition (θ ~ π /4) is at SG ~ 50 nm, and the strong interaction ( θ > π /4) is at SG~40 nm, see the shaded zone in FIGS. 11A and 11B.

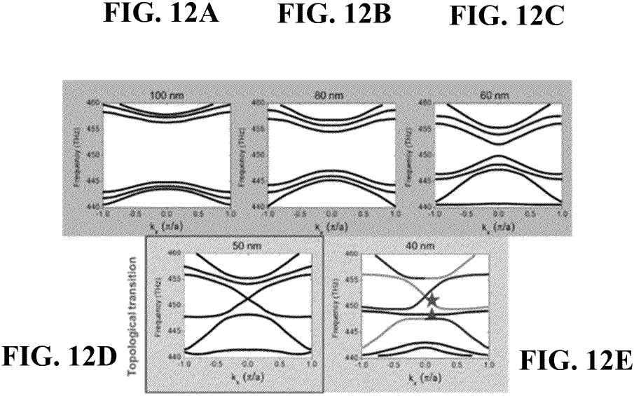

In order to confirm the topological behavior of the proposed device, where a strong interaction region was found (FIG. 11B), the band diagram for a set of SGs was calculated where this condition was matched. The results are shown in FIGS. 12A-12E, where it can be seen that the topological transition occurs for SG~50 nm, while the robust edge modes emerge near SG~40 nm. A clear signature of topological behavior, as disclosed in Mittal, et al., “Measurement of topological invariants in a 2D photonic system,” Nat. Photonics, 10, 180-183 (2016) and Liang, et al., “Optical resonator analog of a two-dimensional topological insulator,” Phys. Rev. Lett., 110, 203904 (2013), the disclosures of which are incorporated herein by reference in their entireties, was the collapse of the bulk band to a point (SG~50 nm), and to reopen later (e.g. for SG~40 nm), allowing the edge modes to appear as shown in FIGS. 12A-12E for SG = 40 nm.

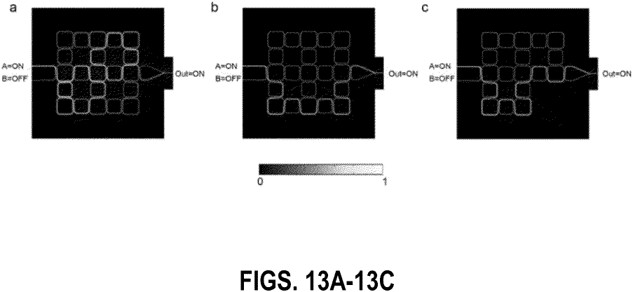

FIGS. 13A-13C demonstrate the mode profiles selected at the triangle and star marks in FIG. 12E for SG = 40 nm. In the case of the bulk mode (FIG. 13A) (triangle for SG=40 nm in FIG. 12E), light transmitted through the body of the device, while for the edge mode (FIG. 13B), it followed the perimeter of the device (star for SG= 40 nm in FIG. 12E), i.e. as an edge mode. Additionally, FIG. 13C demonstrates the robustness of the optical logic circuit device; after removing one lattice site, the mode continued propagating along the new, modified edge. These images confirm the topological behavior of the device.

### Example 4 - Two Bit Calculator Based on TPES Logic Gates

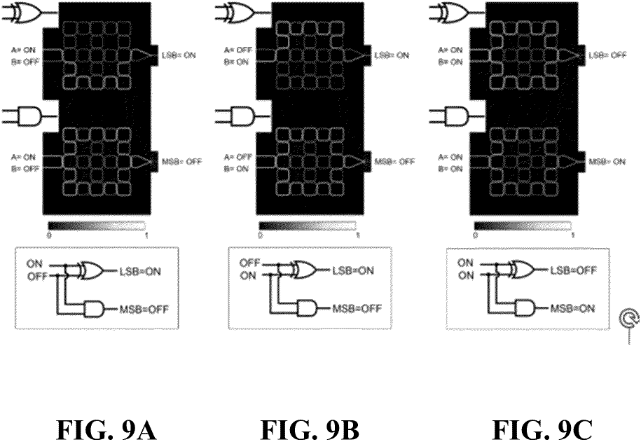

In order to demonstrate the ability of the proposed optical logic circuit device to be used as building block of an all-optical computer, a basic computation was performed in a simple calculator made by the combination of XOR and AND logic gates, also called a half-adder, as disclosed in Shiva, Introduction to logic design (Scott, Foresman and Company, 1988), the disclosure of which is incorporated herein by reference in its entirety. This calculator had two inputs (A, B) and two outputs, called the lowest significant bit (LSB) and the most significant bit (MSB), and this application is considered a two bit calculator. Using this rudimentary computation device, the sums 1+0 and 1+1 were calculated, i.e. ON plus OFF and ON plus ON using the optical logic circuit device methods disclosed herein, with expected decimal results of 1+0=1 and 1+1=2, but in binary code LSB=1 (1) and MSB=1 (2). The summarized results are presented in FIGS. 9A-9C.

The most important advantage of using the topological nature of the proposed logic gates, is that the inclusion of defects in the structure of the components of the proposed calculator had null effect on the results, ensuring an outstanding performance compared with any non-topological device, as discussed in Singh, et al., “All-optical logic gates: Designs, classification, and comparison,” Adv. Opt. Technol., 1-13 (2014) and Jandieri, et al., “Realization of true all-optical AND logic gate based on nonlinear coupled air-hole type photonic crystal waveguides,” Opt. Express, 26, 19845 (2018), the disclosures of which are incorporated herein by reference it their entireties.

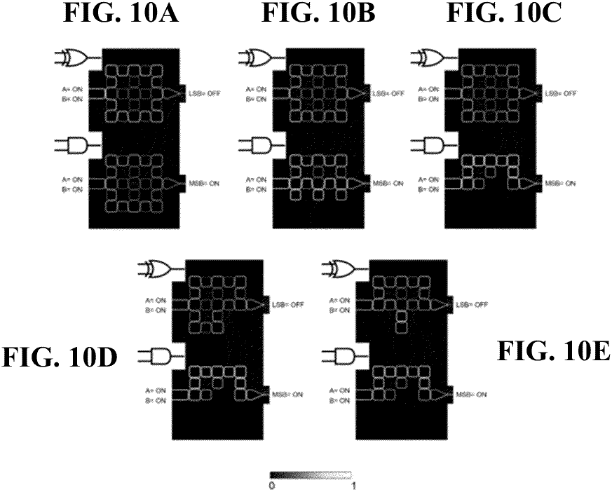

One of the most important features of the proposed optical logic circuit device is its robustness, i.e., calculations are not affected by inclusion of defects. Using the same device as before, the robustness of the two calculator was tested by performing the calculation of decimal 1+1 = 2 or in binary code LSB = 0 and MSB = 1, as shown in FIGS. 9A-9C. It is clear that the result was not affected by the inclusion of strong defects in one of the devices (see FIGS. 10B and 10C). More important is that with the inclusion of defects representing more than one lattice site in each device, the calculation was still performed correctly (see FIGS. 10D and 10E). This robustness demonstration was only achievable by the use of TPESs that continue to propagate although the shape of the device has changed.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed is:

1. An optical logic circuit device comprising:
a first input port and a second input port;
a symmetric arrangement of waveguides coupled to the first input port and the second input port, the symmetric arrangement of waveguides having a pair of topologically protected edge states that provide propagation paths through the symmetric arrangement of waveguides; and
an output port coupled to the symmetric arrangement of waveguides.

2. The device of claim 1, wherein the symmetric arrangement of waveguides comprises a plurality of site rings and a plurality of link rings separated by a separation gap.

3. The device of claim 2, wherein each of the plurality of site rings and the plurality of link rings that are separated by the separation gap are configured to be evanescently coupled.

4. The device of claim 2, wherein the plurality of site rings and the plurality of link rings are arranged in a lattice structure.

5. The device of claim 2, wherein the plurality of site rings and the plurality of link rings are surrounded by a dielectric medium.

6. The device of claim 2, wherein the separation gap is determined based on the size of the plurality of link rings and site rings and a propagation wavelength.

7. The device of claim 2, wherein the plurality of site rings and the plurality of link rings are rectangular shaped with rounded corners.

8. The device of claim 2, wherein the plurality of site rings and the plurality of link rings are formed from TiO₂ or silicon.

9. The device of claim 2, wherein the plurality of site rings have a resonant condition and the link rings are anti-resonant.

10. An optical computing device comprising a plurality of the optical logic circuit devices of claim 1.

11. The optical computing device of claim 10, wherein the symmetric arrangement of waveguides for each of the optical logic circuit devices comprises a plurality of site rings and a plurality of link rings separated by a separation gap.

12. A method of operating the optical logic circuit device of claim 1, the method comprising:
selectively providing excitation energy to the first input port and the second input port, wherein the symmetric arrangement of waveguides transmit light through the propagation paths to the output port only when excitation energy is applied to either the first input port or the second input port.

13. The method of claim 12 further comprising:
providing the excitation energy simultaneously to the first input port and the second input port at a phase difference to alter light transmitted to the output port.

14. The method of claim 13, wherein the phase difference is π such that no light is transmitted to the output port.

15. The method of claim 13, wherein the phase difference is zero such that light is transmitted to the output port.

16. The method of claim 13, wherein the optical gate device provides one of an OR gate, an XOR gate, or an AND gate.

17. A method of forming an optical logic gate comprising:
providing a first input port and a second input port;
coupling a symmetric arrangement of waveguides to the first input port and the second input port, the symmetric arrangement of waveguides having a pair of topologically protected edge states that provide propagation paths through the symmetric arrangement of waveguides; and
coupling an output port to the symmetric arrangement of waveguides.

18. The method of claim 17, wherein the symmetric arrangement of waveguides for each of the optical logic circuit devices comprises a plurality of site rings and a plurality of link rings separated by a separation gap.

19. The method of claim 18, wherein the plurality of site rings and the plurality of link rings are formed using electron beam lithography.

20. The method of claim 19, wherein the plurality of site rings and the plurality of link rings are formed from TiO₂ or silicon.
